(19) United States
(12) Patent Application Publication
(10) Pub. No.: US 2005/0045278 A1
(43) Pub. Date: Mar. 3, 2005

(54) Plate evaporator

(76) Inventor: Shu-Ju Lin, Taipei (TW)

Correspondence Address: RABIN & CHAMPAGNE, P.C.;Suite 500, 1101 14th Street, N.W., Washington, DC, 20005, US

(21) Appl. No.: 10/647,294

(22) Filed: Aug. 26, 2003

(51) Int. Cl. B01D 1/00; F28D 7/02; F28F 3/00

(52) U.S. Cl. 159/28.6; 159/906; 165/165; 165/166

(57) ABSTRACT

A plate evaporator includes a first thermal conductive element and a second thermal conducive element. The rim of the first thermal conductive element is formed with a first joining portion. The second thermal conductive element is like a cap having a second joining portion at the rim and correspondent to the first joining portion of the first thermal conductive element. Therefore, upon assembling the two thermal conductive elements, the first and second joining portions are engaged. When brazing, only the joining portions are at high temperature. The temperature rise does not apply to the whole thermal conductive elements and does not influence the strength of the structure.

### BACKGROUND OF THE INVENTION

1. Field of the Invention

The invention generally relates to a plate evaporator applicable to heat dissipation, and in particular relates to a plate evaporator with higher manufacturing yield rate.

2. Related Art

Plate heat dissipaters similar to the one illustrated in FIG. 1 are developed. The plate heat dissipater, or evaporator, mainly includes a braze condenser 11 and an evaporator 12 formed into two caps. The outer surface of the condenser 11 is formed with fins 13 for heat dissipation. The inner surface of the condenser 11 is formed with some reinforced portions 15a in order to prevent from deformation during fabrication process. Inside the evaporator 12, there are capillary structure 14 and reinforced portions 15b correspondent to the reinforced portions 15a of the condenser 11 for the same strength purpose. There is also working fluid 16 actuated through the capillary structure 14 after the condenser 11 and the evaporator 12 being jointed.

There are mainly two conventional methods for making the plate evaporator. One is first forming the reinforced portions 15a in the condenser 11, forming the capillary structure 14 and the reinforced portions 15b in the evaporator 12. Then, tin-soldering the fins 13 on exterior surface of the condenser 11. And then, brazing the rims of the condenser 11 and the evaporator 12 and jointing the two. Finally, vacuuming the interior and filling the working fluid 16. Since the brazing temperature is high and easy to meld the tin of the fins 13 and loose the fins 13 from the condenser 11 during brazing, the yield rate of finishing the plate evaporator is low.

The other method is first forming the reinforced portions I Sa in the condenser 11, forming the capillary structure 14 and the reinforced portions 15b in the evaporator 12. Then, brazing the rims of the condenser 11 and the evaporator 12 and jointing the two. And then, tin-soldering the fins 13 on exterior surface of the condenser 11, vacuuming the interior and filling the working fluid 16. Finally, soldering the fins 13 on surface of the condenser 11. However, the condenser 11 and the evaporator 12 are easy to be deformed by expansion of the working fluid 16 during soldering, and the component is failed for use.

In conclusion, the conventional manufacturing process for plate evaporator has the following drawbacks:
1) The quality of the capillary structure 14 due to oxidation in welding process is hard to be controlled;
2) The physical characteristics of the plate evaporator are varied, and strength is decreased, due to the high temperature of brazing;
3) The manufacturing cost is increased for the high temperature brazing;
4) Some graphite fixtures are required for supporting the components during brazing. The fixtures are easy to be damaged because force is applied on.

### SUMMARY OF THE INVENTION

The object of the invention is to provide a plate evaporator that has a high yield rate of manufacturing.

A plate evaporator according to the invention includes a first thermal conductive element and a second thermal conducive element. The rim of the first thermal conductive element is formed with a first joining portion. The second thermal conductive element is like a cap having a second joining portion at the rim and correspondent to the first joining portion of the first thermal conductive element. So that, upon assembling the two thermal conductive elements, the first and second joining portions are engaged. When brazing, only the joining portions are at high temperature. The temperature rise does not apply to the whole thermal conductive elements and does not influence the strength of the structure.

Also, no graphite fixture is required so as to save cost, and a high yield rate is achieved.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is sectional view of a conventional plate evaporator;

FIG. 2 is a sectional view of a plate evaporator as a first embodiment the invention; and

FIG. 3 is a sectional view of a plate evaporator as a second embodiment of the invention.

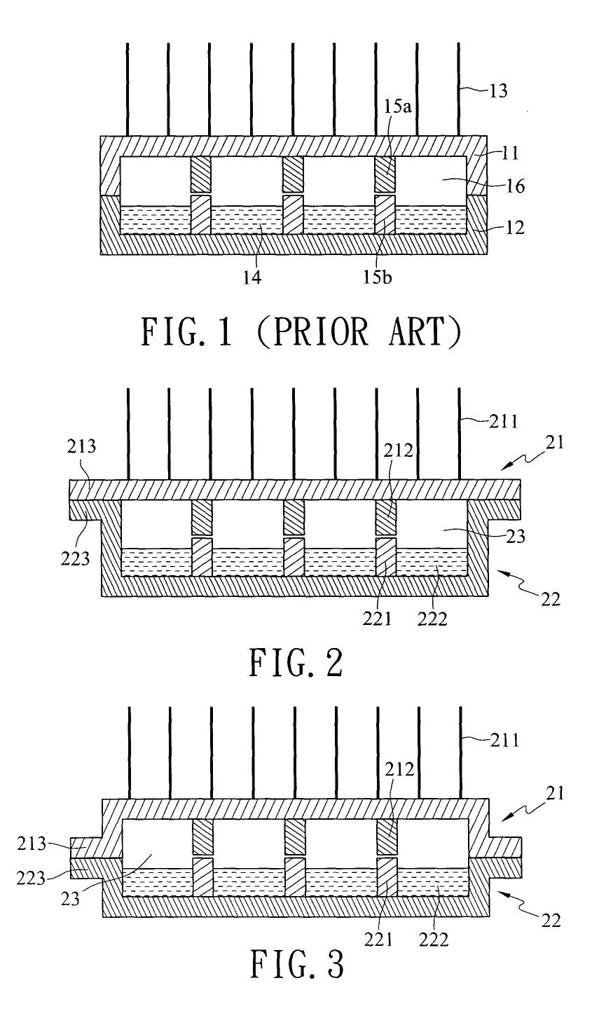

### DETAILED DESCRIPTION OF THE INVENTION

As shown in FIG. 2, a plate evaporator as a first embodiment of the invention includes a first thermal conductive element 21 as a condenser, and a second thermal conductive element 22 as an evaporator. The first thermal conductive element is a plate element having outer surface tin-soldered with a plurality of heat-dissipation fins 211, and inner surface formed with first reinforced blocks 212. The reinforced blocks 212 are used to prevent the first thermal conductive element 21 from deformation during manufacturing process. The rim of the first thermal conductive element 21 is formed with a first joining portion 213.

The second thermal conductive element 22 is like a cap. Second reinforced blocks 221 are formed on inner surface of the second thermal conductive element 22 and correspondent to the first reinforced blocks 212 for preventing the second thermal conductive element 22 from deformation during manufacturing process. Capillary structure 222 is also formed on the inner surface. The rim of the second thermal conductive element 22 is formed with a second joining portion 223 correspondent to the first joining portion 213 of the first thermal conductive element 21.

During manufacturing, the quality of capillary structure 222 is first checked. Then, engaging the first and second thermal conductive elements 21, 22 to engage the first joining portion 213 with the second joining portion 223. The first reinforced blocks 212 also correspond to the second reinforced blocks 221. When brazing the first and second joining portions 213, 223, heat is not applied to the whole thermal conductive elements 21, 22, so that the oxidation of the capillary structure 222 is limited and the quality is controlled. Only the joining portions 213 and 223 are brazed, the temperature rise does not influence the strength of the whole structure. No graphite fixture is required in the process, the cost is reduced, and yield rate is increased. After joining the first and second thermal conductive elements 21, 22, the jointed component is vacuumed and filled with a suitable amount of working fluid 23 for heat-exchanging functions through the capillary structure 222.

As shown in FIG. 3, a plate evaporator as a second embodiment of the invention includes a first thermal conductive element 21 as a condenser, and a second thermal conductive element 22 as an evaporator. The first thermal conductive element is like a cap having outer surface tin-soldered with a plurality of heat-dissipation fins 211, and inner surface formed with first reinforced blocks 212. The reinforced blocks 212 are used to prevent the first thermal conductive element 21 from deformation during manufacturing process. The rim of the first thermal conductive element 21 is formed with a first joining portion 213.

The second thermal conductive element 22 is like a cap. Second reinforced blocks 221 are formed on inner surface of the second thermal conductive element 22 and correspondent to the first reinforced blocks 212 for preventing the second thermal conductive element 22 from deformation during manufacturing process. Capillary structure 222 is also formed on the inner surface. The rim of the second thermal conductive element 22 is formed with a second joining portion 223 correspondent to the first joining portion 213 of the first thermal conductive element 21.

During manufacturing, the quality of capillary structure 222 is first checked. Then, engaging the first and second thermal conductive elements 21, 22 to engage the first joining portion 213 with the second joining portion 223. The first reinforced blocks 212 are also correspondent to the second reinforced blocks 221. When brazing the first and second joining portions 213, 223, heat is not applied to the whole thermal conductive elements 21, 22, so that the oxidation of the capillary structure 222 is limited and the quality is controlled. Only the joining portions 213 and 223 are brazed, the temperature rise does not influence the strength of the whole structure. No graphite fixture is required in the process, the cost is reduced, and yield rate is increased. After joining the first and second thermal conductive elements 21, 22, the jointed component is vacuumed and filled with a suitable amount of working fluid 23 for heat-exchanging functions through the capillary structure 222.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plate evaporator, comprising:
a first thermal conductive element having a first joining portion formed at rim thereof, and
a second thermal conductive element which is like a cap having a second joining portion formed at rim thereof and correspondent to said first joining portion, during assembling said first and said second thermal conductive elements, said first and said second joining portions are engaged.

2. A plate evaporator according to claim 1, wherein outer surface of said first thermal conductive element is formed with a plurality of heat-dissipation fins.

3. A plate evaporator according to claim 1, wherein said first thermal conductive element is a plate element.

4. A plate evaporator according to claim 1, wherein said first thermal conductive element is like a cap having said first joining portion formed on rim of said cap.

5. A plate evaporator according to claim 1, wherein said first thermal conductive element formed with first reinforced blocks in inner surface thereof, said second thermal conductive element formed with second reinforced blocks in inner surface thereof and corresponding to said first reinforced blocks, therefore, said first and said second reinforced blocks corresponding to each other when said first and said second thermal conductive elements are joined.

6. A plate evaporator according to claim 1, wherein a working fluid is filled after said first and said second thermal conductive elements are jointed.

7. A plate evaporator according to claim 1, wherein said second thermal conductive element is formed with capillary structure.
